(19) United States
(12) Patent Application Publication
(10) Pub. No.: US 2016/0086579 A1
(43) Pub. Date: Mar. 24, 2016

(54) Apparatus and Method for Conveying an Item of Information

(71) Applicant: Robert Bosch GmbH, Stuttgart (DE)

(72) Inventors: Markus Engelhardt, Moessingen (DE); Desmond Low, Stuttgart (DE); Alexander Grosch, Winnenden (DE)

(21) Appl. No.: 14/854,794

(22) Filed: Sep. 15, 2015

(30) Foreign Application Priority Data
Sep. 18, 2014 (DE) 10 2014 218 769.9

(51) Int. Cl. G09G 5/10; G09G 5/02

(52) U.S. Cl. CPC G09G 5/10; G09G 5/02; G09G 2320/0626; G09G 2320/0686; G09G 2320/08; G09G 2320/10; G09G 2354/00

(57) ABSTRACT

An apparatus for conveying an item of information includes a front display configured to display the item information, and a rear luminous element configured to illuminate a background of the apparatus based on the unit of information even when the front display is switched off.

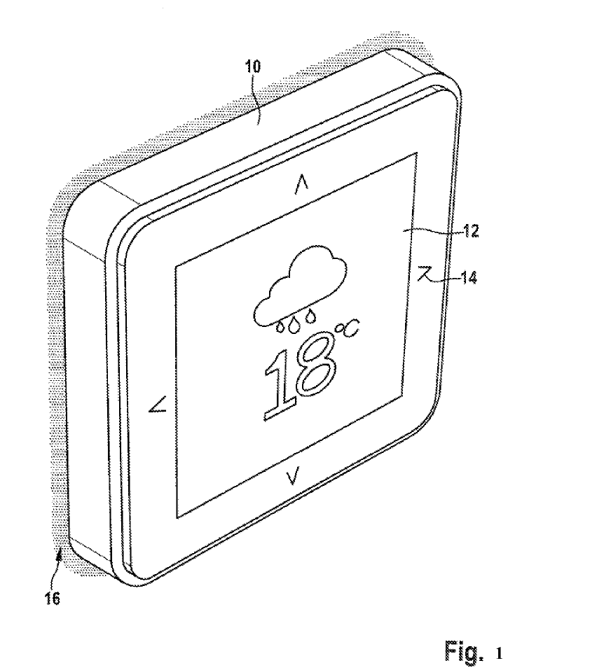

### PRIORITY CLAIM

This application claims priority under 35 U.S.C. §119 to patent application number DE 10 2014 218 769.9, filed on Sep. 18, 2014 in Germany, the disclosure of which is incorporated herein by reference in its entirety.

### BACKGROUND

The present disclosure relates to an apparatus for conveying an item of information. The present disclosure also relates to a corresponding method, a corresponding computer program and a corresponding storage medium.

In technology, any apparatus for optically signaling variable information is generally expressed under the umbrella term of “display”. In everyday life, displays of the generic type form a typical interface between a person and a technical process or the environment.

Known displays have extremely different designs. In the field of building services for instance, displays which are suitable for wall mounting on top of or under plaster are used. Optical displays, in particular, are widespread in this field in view of their ergonomic properties according to DIN EN 8942-2[1]. Such information displays typically display details on a screen which is permanently switched on.

### SUMMARY

The disclosure provides an apparatus for conveying an item of information, a corresponding method, a corresponding computer program and a corresponding storage medium according to the description below.

One advantage of this solution lies in the proposed illumination of the housing and/or the background of the apparatus. Such illumination can be used, for instance, to signal the status of the device or to provide the user with visible feedback to any voice command, for example. In addition, the use of the illumination as night light or orientation light is conceivable. These two functions are also advantageous when the device does not have a display.

In this case, background illumination means that luminous means fitted to the rear of the apparatus illuminate the area facing away from the display, for example a wall which is used for mounting purposes.

Further advantageous configurations of the disclosure are stated in the following description. The display can be switched on and off while the luminous means illuminates the background, with the result that the luminous means alone indicates the presence of an item of information by illuminating the background when the display is switched off. This embodiment is based on the knowledge that the user often does not require all of the displayed information or is even overwhelmed thereby. Therefore, the selective operation of the display reduces the service life of the display and potentially saves energy. In addition, the background illumination can discreetly indicate available information without inundating the user with details without being requested to do so.

The apparatus is preferably configured in such a manner that it assigns the information to one category from a plurality of predefined categories, the luminous means illuminating the background on the basis of the category. In this manner, the apparatus can be used to first of all signal only the category of the information using the background illumination and to switch on the display only if necessary to possibly display further details.

Illumination of the background in different colors and with different brightnesses depending on said category comes into consideration, in particular. In this case, it is advisable to also display the information in different colors and with different brightnesses depending on the category when the display is switched on. Such a configuration takes into account the cognitive psychological fact that the brightness and color of a light signal are processed in a particularly rapid and reliable manner as cues, even in the peripheral perception area.

For instance, a warning, a traffic report, a weather forecast, an appointment reminder, an email, an item of building services status information and an input request may be assigned to different categories by the apparatus. Such a fixed assignment of the background illumination to the predefined image of an information category can be implemented at low unit costs using a logic-based controller.

With respect to possible input devices, an electromechanical button, a capacitive touch button, a touch sensor on the display, a proximity sensor or a microphone can be considered, in particular. It is therefore possible to activate the display in various ways.

According to one example scenario, the apparatus can be configured in such a manner that the luminous means illuminates the background in red if the information is a warning, and the display displays the information or its background at least partially in red when the display is switched on. Such an embodiment uses the signal effect of the color red, which is perceived in a particularly intense manner and ensures clear perceptibility even at a great distance. This effect can be intensified further by varying the brightness.

### BRIEF DESCRIPTION OF THE DRAWINGS

One exemplary embodiment of the disclosure is illustrated in the drawing and is described in more detail below.

The FIGURE shows the perspective view of an apparatus according to one embodiment of the disclosure.

### DETAILED DESCRIPTION

The FIGURE illustrates the structural configuration of an apparatus 10 fitted to a wall according to one embodiment of the disclosure. It goes without saying that the apparatus may be fitted instead to another flat surface using a suitable mount or using flush mounting without departing from the scope of the disclosure.

The described apparatus 10 is used—for instance as part of a smart home infrastructure—to convey an item of information which could prove to be relevant to its user. In order to display said information, the apparatus 10 has a display 12, which is activated only upon request by the user, on its front side facing the user. Information considered to be relevant may relate to the apparatus 10 or the smart home system itself, may relate to information from the outside or else may relate to the interaction with the human user. A prioritization stipulates which of a plurality of information categories is preferably signaled. The alternating display of a plurality of categories is also possible and useful.

Four input devices in the form of capacitive touch buttons are used in the present case to switch on the display 12, alternative embodiments of the disclosure being able to use, for instance, conventional electromechanical buttons, touch sensors on the display (12), proximity sensors or suitable microphones for voice control.

According to the FIGURE, luminous means which are in the form of a plurality of LEDs and are concealed by their housing are additionally provided on the rear side of the apparatus 10, which luminous means can represent different colors and brightnesses and, when the luminous means are fitted accordingly together with a light guide, illuminate the surface behind. The background illumination implemented in this manner can be controlled on the basis of the available information. While the display 12 is switched off for instance, the luminous means indicates the information available for retrieval by appropriately illuminating the background 16.

In this case, the apparatus 10 is configured in such a manner that the luminous means illuminates the background 16 depending on a predefined category to which the information has been assigned. The color and brightness of the background illumination, in particular, are varied according to the category detected by the apparatus 10, the display 12 also displaying the information in different colors and with different brightnesses depending on the category when the user switches on the display 12.

The proposed assignment depends, for example, on whether the information is a warning, a traffic report, a weather forecast, an appointment reminder, an email, an item of building services status information or an input request. For the special case of a warning, the apparatus 10 is configured in this case such that the luminous means illuminates the background 16 in red and the display 12 presents a warning on a red background when it is switched on.

What is claimed is:

1. An apparatus for conveying an item of information, comprising:
a front display configured to display the item of information; and
a rear luminous element configured to illuminate a background of the apparatus based on the item of information.

2. The apparatus according to claim 1, wherein:
the front display is configured to be switched on and off while the rear luminous element illuminates the background, and
the apparatus is configured such that the rear luminous element indicates the item of information by illuminating the background while the front display is switched off.

3. The apparatus according to claim 2, wherein:
the apparatus is configured to assign the item of information to one category from a plurality of predefined categories, and
the apparatus is configured such that the rear luminous element illuminates the background based on the one category.

4. The apparatus according to claim 3, wherein:
the apparatus is configured such that the rear luminous element illuminates the background in differing colors and with differing brightnesses depending on the category, and
the apparatus is configured such that the front display displays the item of information in differing colors and with differing brightnesses depending on the category when the front display is switched on.

5. The apparatus according to claim 4, wherein the apparatus is configured to assign a warning, a traffic report, a weather forecast, an appointment reminder, an email, an item of building services status information, and an input request to different categories.

6. The apparatus according to claim 5, further comprising at least one input device configured to switch on the front display, the at least one input device being selected from an electromechanical button, a capacitive touch button, a touch sensor on the front display, a proximity sensor, and a microphone.

7. The apparatus according to claim 5, wherein:
the apparatus is configured such the rear luminous element illuminates the background in red if the item of information is a warning; and
the apparatus is configured such that the front display displays the item of information at least partially in red when the front display is switched on.

8. A method for conveying an item of information using an apparatus, the method comprising:
displaying the item of information on a front display; and
illuminating a background of the apparatus with a luminous element depending on the item of information.

9. The method of claim 8, wherein the method is carried out by a computer program.

10. The method of claim 9, wherein the computer program is stored on a machine-readable storage medium.
